(19) United States
(12) Patent Application Publication
(10) Pub. No.: US 2015/0113046 A1
(43) Pub. Date: Apr. 23, 2015

(54) DATA COMMUNICATION NETWORK

(71) Applicant: ROSBERG SYSTEM AS, Karmsund (NO)

(72) Inventor: Odd Helge Rosberg, Aksdal (NO)

(21) Appl. No.: 14/402,459

(22) PCT Filed: May 21, 2013
(86) PCT No.: PCT/EP2013/060414

§ 371 Date: Nov. 20, 2014

(30) Foreign Application Priority Data
May 21, 2012 (GB) 1208915.7

(51) Int. Cl. H04L 29/08; H04L 29/06

(52) U.S. Cl. CPC H04L 67/10; H04L 67/42
USPC 709/203

(57) ABSTRACT

A data communication network comprises a remote server, a local server in data communication with remote server via a remote telecommunication network and client computing devices in data communication with local server via a local data network. Local server is configured to receive data from remote server and distribute the received data to client computing devices via local data network. Local server comprises a plurality of plug computers in data communication with at least one other of the plug computers via local data network. At least one of the plug computers is configured to receive data from remote server via remote telecommunication network and communicate the received data to at least one other of the plug computers via local data network. Each client computing device is in data communication with at least one of the plug computers via local data network to receive data received from remote server.

### BACKGROUND

In many situations, such as schools, it is desirable to provide a low cost, scalable data communication network including server capability that can be managed easily. Traditional network architectures are expensive in terms of hardware cost and the complexity of configuration. The present invention seeks to provide an alternative solution.

### BRIEF SUMMARY OF THE DISCLOSURE

In accordance with the present invention there is provided a data communication network comprising a remote server, a local server in data communication with the remote server via a remote telecommunication network and a plurality of client computing devices in data communication with the local server via a local data network. The local server is configured to receive data from the remote server and to distribute the received data to the client computing devices via the local data network. The local server comprises a plurality of plug computers, each plug computer in data communication with at least one other of the plug computers via the local data network. At least one of the plug computers is configured to receive data from the remote server via the remote telecommunication network and to communicate the received data to at least one other of the plug computers via the local data network. Each client computing device is in data communication with at least one of the plug computers via the local data network, whereby to receive data received from the remote server.

Thus, in accordance with embodiments of the invention there is provided a relatively low cost, flexible network architecture that is suited to use in, for example, schools.

As used herein the term “plug computer” refers to a low-cost, low form factor computing device having the capability to act as a server. Typically, the largest dimension (width, height depth) of the housing of a plug computer is less than 20 cm. The plug computer may be provided in a housing which includes as an integral part of the housing a plug for connection to a mains power socket. Alternatively, a plug computer may be powered via a network connection, such as an Ethernet connection. A plug computer typically comprises at least a microprocessor, memory, data storage such as a hard disk drive or solid state disk drive, a wired network adapter and a wireless network adapter. The plug computer may be provided without a video card, which means that it cannot be connected directly to a computer monitor.

In embodiments of the invention, the remote telecommunication network may be any suitable network, for example the Internet. The plug computers may be mutually connected by the local data network. The local data network may comprise a wireless network connecting each of the plug computers. Alternatively or in addition, the local data network may comprise a wired network, such as an Ethernet network, connecting each of the plug computers. The plug computers may be powered by the wired network. The local data network may further comprise a wireless network service, and the client computing devices may be in data communication with a respective plug computer via the wireless network. Thus, each plug computer may provide a wireless access point for one or more client computing devices.

Each plug computer may comprise data storage and be configured to provide access to such data storage by the client computing devices.

The invention extends to a plug computer configured to operate as part of the local server in a data communication network as described. The invention further extends to computer software which configures a general purpose plug computer to operate as such a plug computer. The invention also extends to computer software which configures a general purpose computing device to operate as a client computing device in the data communication network.

### BRIEF DESCRIPTION OF THE DRAWINGS

Embodiments of the invention are further described hereinafter with reference to the accompanying drawings, in which:

FIG. 1 is a schematic representation of a data communication network according to an embodiment of the invention; and

FIG. 2 is a schematic representation of a data communication network according to an alternative embodiment of the invention.

### DETAILED DESCRIPTION

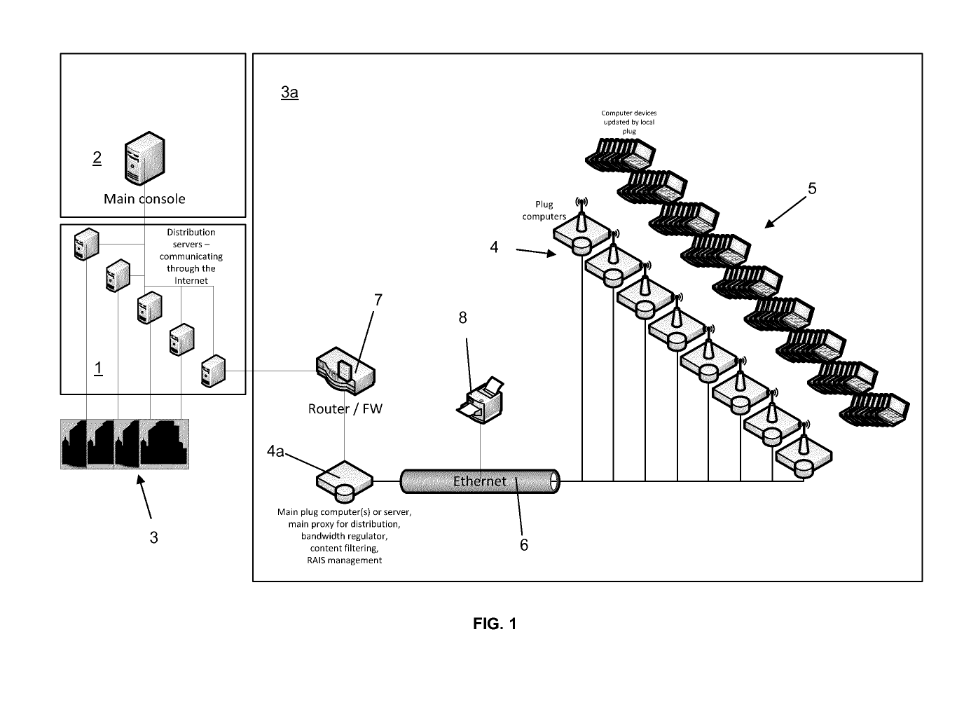

With reference to FIG. 1, a data communication network according to an embodiment of the invention comprises a plurality of remote servers 1 at a first location. The operation of the remote servers 1 is controlled by a main console 2, which may be physically local to the remote servers 1 or may be remote therefrom. The main console 2 is in data communication with the remote servers 1. Each of the remote servers 1 is in data communication via the Internet with a respective location 3, which may, for example, be a school or an office. A particular location 3a is exemplified in detail in FIG. 1.

At each location, a plurality of plug computers 4 are in wireless data communication with a plurality of client computers 5. The plug computers 4 are in mutual data communication via an Ethernet network 6, which may also provide power to the plug computers 4. A main plug computer 4a is connected to the Ethernet network 6 and also to a router 7, which connects the Ethernet network 6 to the Internet and thereby to the remote server 1. Additional network components, such as network printers 8, are connected to the Ethernet network 6.

Each plug computer 4 is a small form factor computing device incorporating a microprocessor, memory, data storage, such as a hard disk drive or solid state disk drive, a network card and a wireless network card. Additional functionality and communications capability may be provided. The plug computer 4 is provided with a local installation of management system software, and acts like a proxy providing the client computing devices 5 with access to data and services from the remote server 1.

In the embodiment of FIG. 1, the main plug 4a acts as a main control system for the local site 3a. The functionality of the main plug 4a may be provided by one or several plugs depending on the size of the site and the software installed. Adding several plugs computers acting as the main plug 4a will increase the available processing power and disk storage, providing a redundant system, i.e. a “redundant array of independent servers” (RAIS) or a “redundant array of processors” (RAP). The redundant array may comprise at least two plug computers, but preferably three or ideally five or more plug computers to create a truly redundant system.

The main plug computer 4a is the main proxy for the system. All updates from the main management console are distributed to the main plug computer 4a, which in turn distributes the received information to the other plug computers 4, which act as WiFi hotspots throughout the site 3a for the client computing devices 5. Each plug computer 4 acts as a small management system of its own for the client computing devices 5 to which it is connected via WiFi. This reduces pressure on the network because updates to the data from the remote server 1 are distributed throughout all of the plug computers 4.

The main plug computer 4a also contains one or more servers that may provide a range of services, such as Lightweight Directory Access Protocol (LDAP) or Active Director, file, print, mail server, WiFi controller, database servers, firewall, content filtering server, bandwidth regulation server, content management servers, Learning Management System (LMS) servers, etc.

Content that comes from the remote server 1 under the control of the main console 2, such as updates, disk images, programs, backup/recovery, software, files, pictures, other media content, is automatically distributed by giving such traffic low priority out to the relevant plug computers 4 in the relevant location based on a rule or a set of rules that may either be in a directory server (LDAP/AD) in the main plug computer 4a alone, or in a hierarchy of directory servers distributing rights from the overall level down to the individual user.

The distributed plug computers 4, i.e. the other plug computers 4 which are not the main plug computer 4a, act as a replacement for a traditional WiFi access point, and contain a local RADIUS (Remote Authentication Dial In User Service) client to enable managed services at the same level as any other access point. The plug computers 4 may be used as local disk storage for the client computing devices 5. Because each plug computer 4 has processing power and data storage, it can also be managed by the main plug computer 4a to serve as a distributed server farm. By using the same principles as with the main plug computer 4a, a server or set of servers can be configured within the local site enabling a very low cost server system.

The arrangement shown in FIG. 1 has the advantage that the server array is redundant, so that if one plug computer 4 fails, it can simply be replaced and the system can automatically recreate the information and task distribution assigned to the failed plug computer 4. Plug computers 4 can be used as “hot spare” devices that automatically take over the tasks from any failing device.

As mentioned above, the plug computers 4 may be powered by the Ethernet network using Power over Ethernet (PoE), feeding the plug computers with current from a main server room switch. The switch can be connected to an uninterruptable power supply (UPS) and/or generator to provide further resilience to the system.

The system shown in FIG. 1 provides a new and inexpensive way to offer servers and services to computing equipment in a site such as a school. By using the plug computer to create a bundle of resources (processor, disk, WiFi etc . . . ) a complete “package” solution containing all the elements a professional network is provided at the cost of a very simple wireless network.

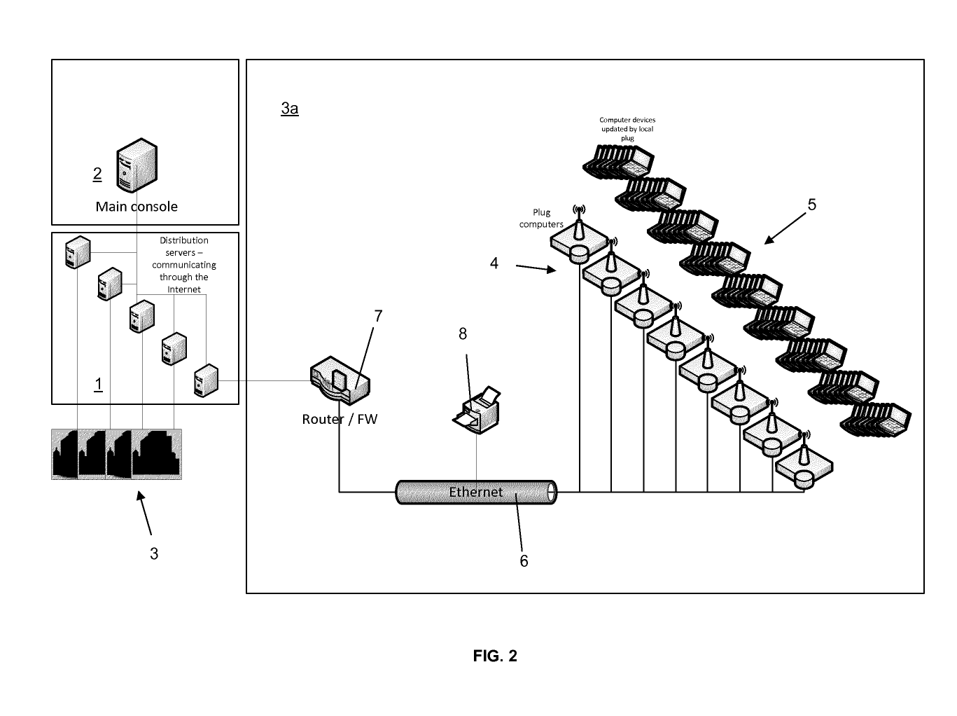

The embodiment of FIG. 2 differs from the embodiment of FIG. 1 only in that there is no designated main plug computer 4a. In this embodiment, each of the plug computers 4 in the distributed array provides the functionality of the main plug computer 4a of the embodiment of FIG. 1.

Throughout the description and claims of this specification, the words “comprise” and “contain” and variations of them mean “including but not limited to”, and they are not intended to (and do not) exclude other components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers or characteristics described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

1. A data communication network comprising:
a remote server;
a local server in data communication with the remote server via a remote telecommunication network; and
a plurality of client computing devices in data communication with the local server via a local data network,
wherein the local server is configured to receive data from the remote server and to distribute the received data to the client computing devices via the local data network and the local server comprises a plurality of plug computers, each plug computer in data communication with at least one other of plug computers via the local data network, and wherein
at least one of the plug computers is configured to receive data from the remote server via the remote telecommunication network and to communicate the received data to at least one other of the plug computers via the local data network, and
each client computing device is in data communication with at least one of the plug computers via the local data network whereby to receive data received from the remote server.

2. The data communication network of claim 1, wherein the remote telecommunication network is the Internet.

3. The data communication network of claim 1, wherein the local data network comprises a wired network connecting each of the plug computers.

4. The data communication network of claim 3, wherein the plug computers are powered by the wired network.

5. The data communication network of claim 3, wherein the local data network further comprises a wireless network and the client computing devices are in data communication with a respective plug computer via the wireless network.

6. A plug computer configured to operate as part of the local server in a data communication network as claimed in claim 1.

7. A non-transitory computer-readable medium encoded with a sequence of instructions which when executed by a processor of a general purpose plug computer enables the general purpose plug computer to operate as a plug computer as claimed in claim 6.

8. A non-transitory computer-readable medium encoded with a sequence of instructions which when executed by a processor of a general purpose computing device enables the processor to operate the computing device as a client computing device in the data communication network of claim 1.

9. The data communication network of claim 4, wherein the local data network further comprises a wireless network and the client computing devices are in data communication with a respective plug computer via the wireless network.
